(19) United States
(12) Patent Application Publication
(10) Pub. No.: US 2026/0260308 A1
(43) Pub. Date: Sep. 3, 2026

(54) IMPROVED TRANSPORTATION AND PAYMENT SYSTEM

(71) Applicant: IFH LIMITED, Queensway, GI (GB)

(72) Inventors: Mark Ishakov, Queensway (GI); Anna Ishakov, Queensway (GI)

(21) Appl. No.: 18/876,094

(22) PCT Filed: Jun. 16, 2023
(86) PCT No.: PCT/IB2023/056269

§ 371 Date: Dec. 17, 2024

Related U.S. Application Data
(60) Provisional application No. 63/353,116, filed on Jun. 17, 2022.

(51) Int. Cl. G06Q 50/40; B60K 35/22; G06Q 20/06; G06Q 20/32; G06Q 20/36; G06Q 30/0226; G06Q 30/0251

(52) U.S. Cl. CPC G06Q 50/40; B60K 35/22; G06Q 20/065; G06Q 20/325; G06Q 20/36; G06Q 30/0226; G06Q 30/0265; G06Q 2220/00

(57) ABSTRACT

A vehicle includes a driver pod, a passenger pod, an electric propulsion system, a power storage device that is rechargeable via at least one of kinetic energy, solar energy, wind energy, or direct input energy. The vehicle also may include a solar charging system, a computer controlled outward facing display and a mining computer adapted to mine cryptocurrency using power from the power storage device. The crypto currency mining computer may be utilized to mine cryptocurrency that may be part of a payment ecosystem including the transportation device. Blockchain may be used to track the cryptocurrency ledger. Cryptocurrency may be earned by the passenger and the driver during a ride and power from the power storage unit may be used to power the mining computer.

### PRIORITY CLAIM

This application claims priority to and the benefit of U.S. Patent Application 63/353,116, filed Jun. 17, 2022, entitled “IMPROVED TRANSPORTATION AND PAYMENT SYSTEM,” the entire contents of which are incorporated herein by reference.

### BACKGROUND

In the past, traditional passenger cars were adapted by users to be taxis or on demand type vehicles. Adaptations were minimal such as a light on the roof, badges on the car, a payment meter and perhaps a divider between the driver and the passenger. However, traditional passenger cars were not designed with being on demand vehicles. As a result, the traditional passenger car does not maximize the on demand passenger experience from a variety of perspectives, from access, to safety to efficiency.

### SUMMARY

An improved transportation system is disclosed. A vehicle includes a driver pod, a passenger pod, an electric propulsion system, a power storage device that is rechargeable via at least one of kinetic energy, solar energy, wind energy, or direct input energy. The vehicle also may include a solar charging system, a computer controlled outward facing display and a mining computer adapted to mine cryptocurrency using power from the power storage device.

The improved transportation system also may include a high speed power transfer station which also may wash the vehicle. The power transfer station may swap out a discharged power storage device with a charged power storage device. In other embodiments, induction is used to transfer power to the power storage units.

In another aspect of the transportation system, a crypto currency system may be utilized. A mining computer may be utilized to mine cryptocurrency that may be part of a payment ecosystem including the transportation device. Blockchain may be used to track the cryptocurrency ledger. Cryptocurrency may be earned by the passenger and the driver during a ride and power from the power storage unit may be used to power the mining computer.

Of course, additional aspects and uses are contemplated and are included.

### BRIEF DESCRIPTION OF THE DRAWING

FIG. 1 may illustrate a front of an example vehicle;

FIG. 2 may illustrate a rear of an example vehicle;

FIG. 2a may be an illustration of an example vehicle with an additional storage rack;

FIG. 3 may illustrate a side view of an example vehicle;

FIG. 3a may be an illustration of an example vehicle with display in the windows;

FIG. 3b may be an illustration of an example vehicle with display in the windows and a rear carrying rack;

FIG. 3c may be an illustration of an example vehicle with the side doors removed;

FIG. 3d may illustrate a side and front view of an example vehicle including a frunk and a front carrying rack;

FIG. 3e may be an illustration of an example vehicle with interior lighting and a rear carrying rack

FIG. 3f may illustrate a cutaway view of a side and back of an example vehicle including luggage storage space;

FIG. 3g may illustrate a cutaway view of a side and back of an example vehicle;

FIG. 4 may illustrate a cutaway view of the side of an example vehicle;

FIG. 5 may illustrate a cutaway view of a side and front of an example vehicle;

FIG. 5a may illustrate a side and front view of an example vehicle including a frunk and a front carrying rack;

FIG. 5b may illustrate a side and front view of an example vehicle including a side platform;

FIG. 5c may illustrate a side and front view of an example vehicle including a side platform acting as a ramp;

FIG. 6 may illustrate a cutaway view of a side and back of an example vehicle;

FIG. 6a may illustrate a cutaway view of a side and back of an example vehicle including luggage storage space;

FIG. 6b may be an illustration of a cutaway view of a side and back of an example vehicle including an additional storage rack;

FIG. 7 may illustrate an overhead view of an example vehicle;

FIG. 7a may illustrate an overhead view of an example vehicle and a seating configuration;

FIG. 7b may illustrate an overhead view of an example vehicle and an additional seating configuration;

FIG. 7c may illustrate an overhead view of an example vehicle and an additional seating configuration;

FIG. 7d may illustrate a seating position;

FIG. 7e may illustrate a driver view;

FIG. 7f may illustrate driver accessories;

FIG. 7g may illustrate driver accessories;

FIG. 7h may illustrate driver accessories;

FIG. 8 may illustrate a side view of a charging and washing station;

FIG. 9 may illustrate the vehicle entering the charging and washing station;

FIG. 10 may illustrate the vehicle passing through the charging and washing station

FIG. 11 may illustrate a skewed view of the vehicle passing through the charging and washing station from a front view;

FIG. 12 may illustrate the vehicle inside the charging and washing station;

FIG. 12a may illustrate the vehicle insider the charging and washing station from a rear view;

FIG. 13 may illustrate a cutaway view of the elements of the charging and washing station;

FIG. 14 may illustrate an overhead view of the charging station;

FIG. 15 may illustrate a sample tax based data flow;

FIG. 16 may illustrate a sample taxi based data flow;

FIG. 17 may illustrate a sample taxi based financial ecosystem;

FIG. 18 may illustrate a sample financial ecosystem; and

FIG. 19 may illustrate a sample crypto computer.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DESCRIPTION

The present disclosure now will be described more fully hereinafter with reference to the accompanying drawings, which form a part hereof, and which show, by way of illustration, specific exemplary embodiments by which the disclosure may be practiced.

These illustrations and exemplary embodiments are presented with the understanding that the present disclosure is an exemplification and is not intended to be limited to any one of the embodiments illustrated. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

In the past, traditional passenger cars were adapted by users to be taxis or on demand type vehicles. Adaptations were minimal such as a light on the roof, badges on the car, a payment meter and perhaps a divider between the driver and the passenger. However, traditional passenger cars were not designed with being on demand vehicles. As a result, the traditional passenger car does not maximize the on demand passenger experience from a variety of perspectives, from access, to safety to efficiency.

An improved transportation system is disclosed. At a high level, a vehicle 100 may include a plurality of wheels, a driver pod, a passenger pod, an electric propulsion system, a power storage device that is rechargeable via at least one of kinetic energy, solar energy, wind energy, or direct input energy. The vehicle 100 also may include a solar charging system, a computer controlled outward facing display and a mining computer adapted to mine cryptocurrency using power from the power storage device.

The improved transportation system also may include a high speed power transfer station which also may wash the vehicle 100. The power transfer station may swap out a discharged power storage device with a charged power storage device. In other embodiments, induction is used to transfer power to the power storage units.

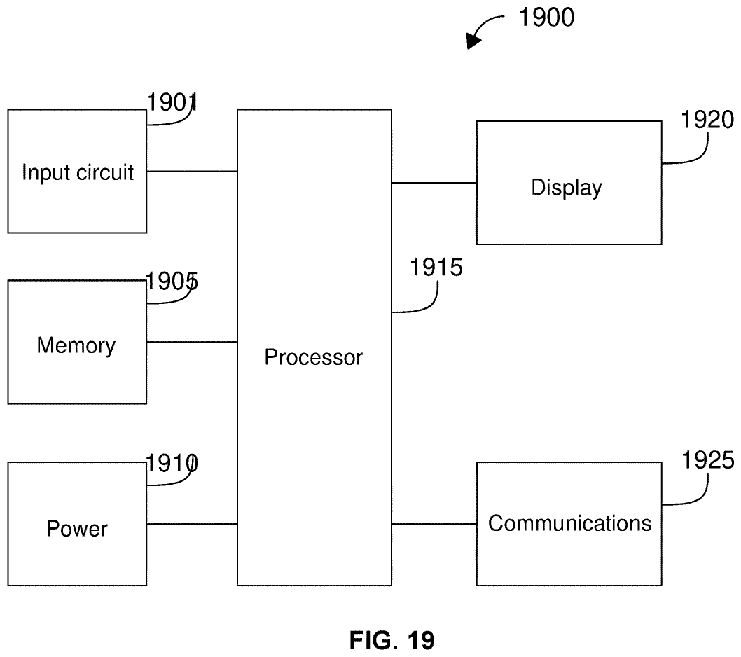

In another aspect of the transportation system, a crypto currency system may be utilized. A crypto mining computer 1900 (FIG. 19) may be utilized to mine cryptocurrency that may be part of a payment ecosystem including the transportation device. Blockchain may be used to track the cryptocurrency ledger. Cryptocurrency may be earned by the passenger and the driver during a ride and power from the power storage unit may be used to power the mining computer.

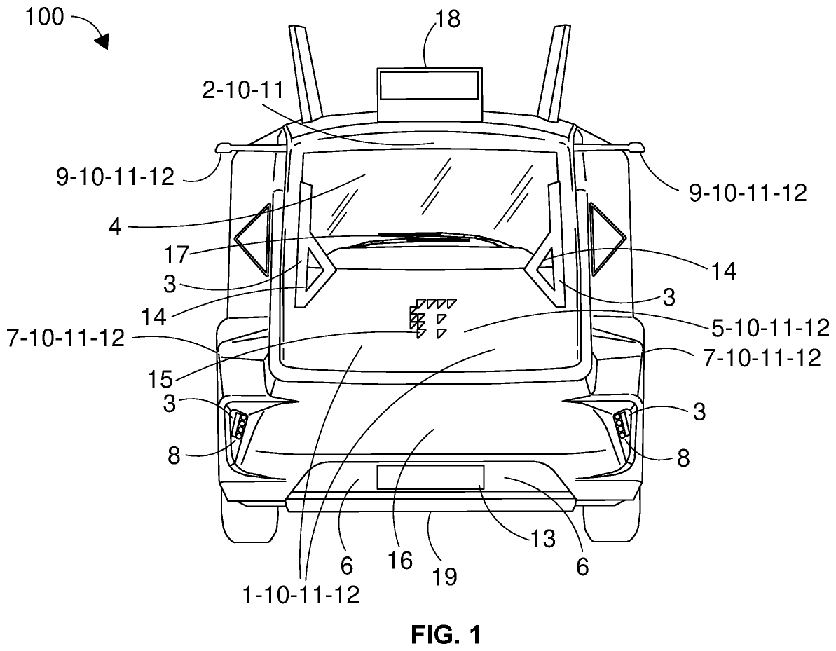

Referring to FIG. 1, the vehicle 100 may include a dash front camera 1. The camera 1 may be a traditional ccd based camera with multiple cameras or may include additional sensors such as LIDAR. A rain sensor 2 may also be included that senses moisture and activate windshield wipers in response to moisture being over a threshold. A light sensor 3 may be included and may sense light and determine when to turn on or off running lights, bright lights, fog lights, etc. A windscreen or wind-shield 4 may be included to provide a clear view of the road and safety to the driver. A hood 5 may be used to provide access to various systems of the vehicle 100 such as the propulsion system and the crypto computer. Front air intakes 6 may be used to provide fresh air to the driver, to keep propulsion equipment cool and to provide power to wind powered generators to provide electricity to the power storage units.

Side blinkers 7 may be provided to provide notice to other drivers or automated driver systems of planned maneuverers. Side blinker may also provide illumination for turns. Front blinker/winkers, Side blinker may also provide illumination for turns. Fog lights 8 may be included to provide illumination in foggy conditions. A lane tracking system 9 may be included which may provide a plurality of cameras in communication with a computer to analyze images from the camera and determine if course corrections are needed. Parking sensors 10 may provide a plurality of cameras in communication with a computer to analyze images from the camera and provide assistance in parking situations. A collision avoidance system 11 may provide a plurality of cameras in communication with a computer to analyze images from the camera and provide assistance in avoiding collisions. A distometer 12 may provide a plurality of cameras and electronics in communication with a computer to analyze images from the camera and provide assistance in determining distance from objects. The vehicle 100 also may have a place for car number 13 which may be useful in identifying a vehicle 100, headlights 14, a place for logo 15, an engine hatch 16, windscreen wiper 17, the display 18 may be retractable to fit into garages and other locations with height restrictions, to show if the taxi is busy/free, slot battery pack 19.

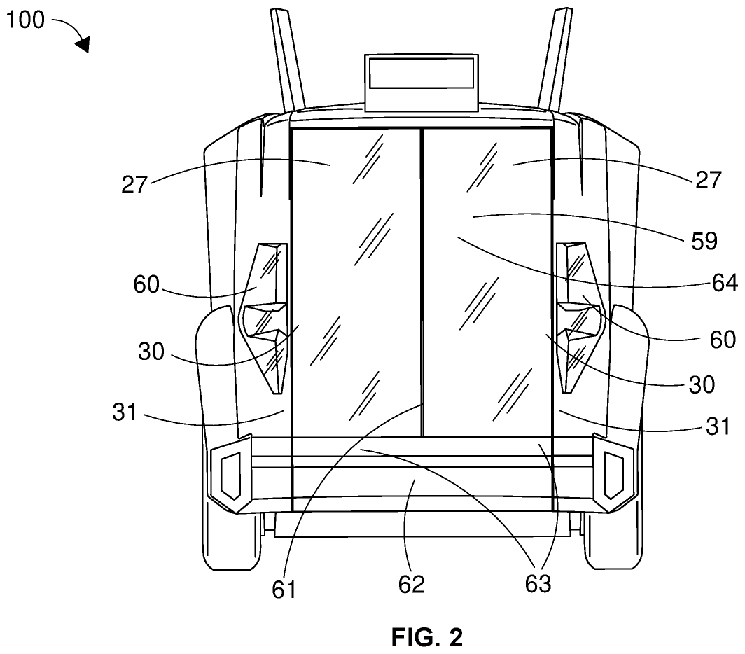

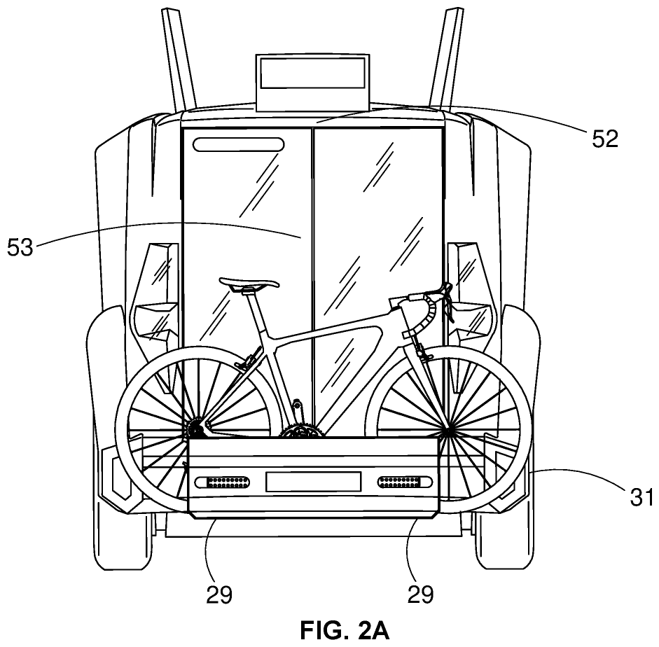

Referring to FIG. 2, looking at the rear of the vehicle 100, there may be back cameras 52. There also may be a back entrance 53. The vehicle 100 may also have rear lights 29, electrically removable bike rack 31 with all necessary lights integrated as shown in FIG. 2a.

### Pods

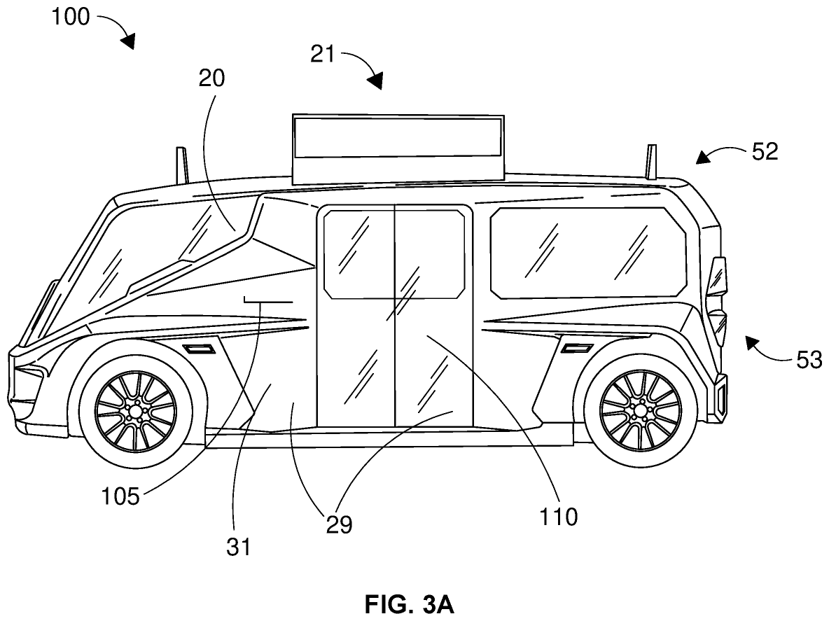

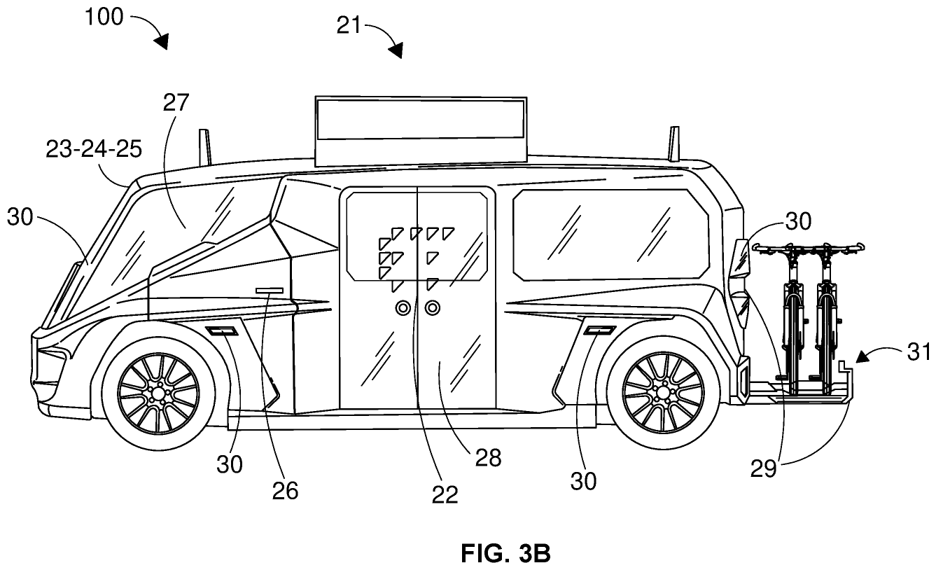

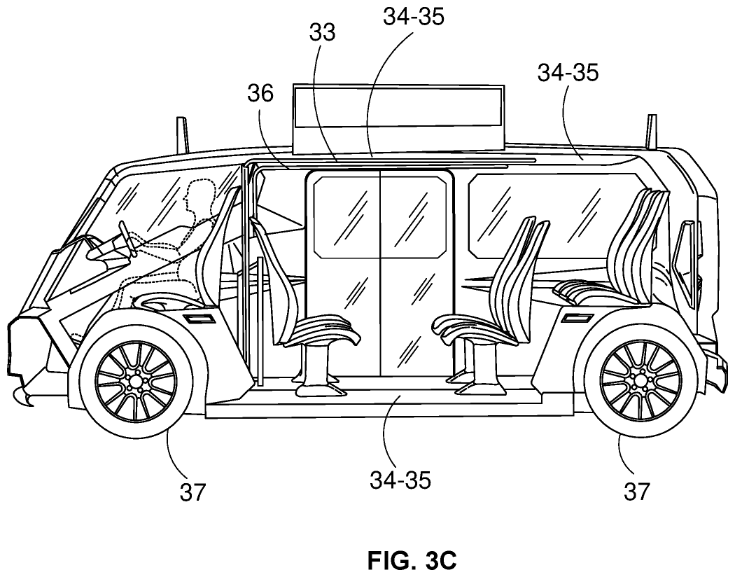

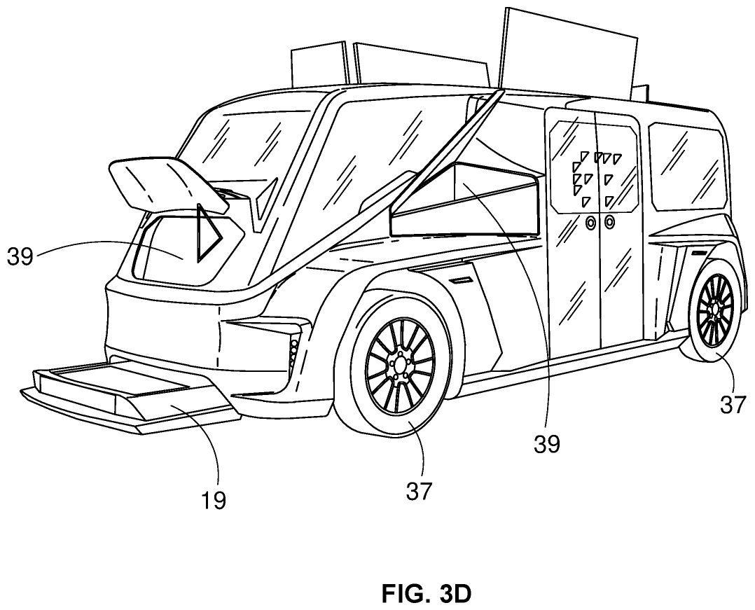

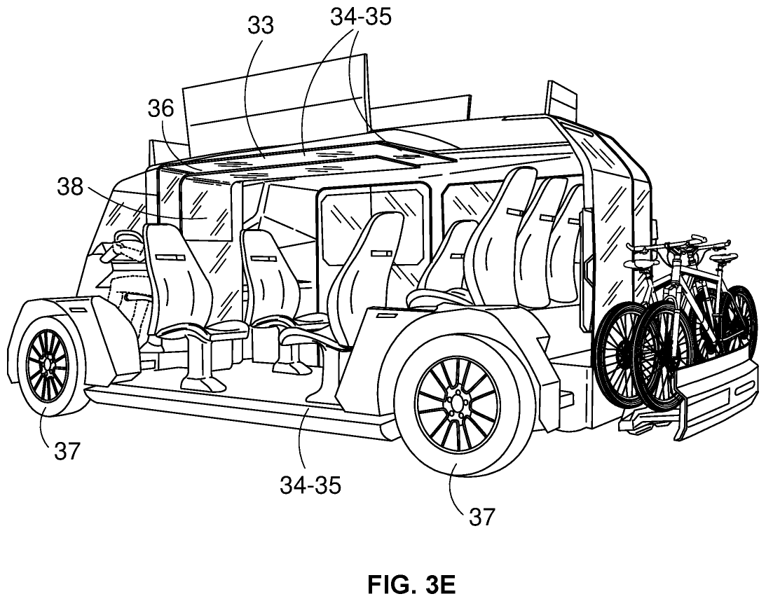

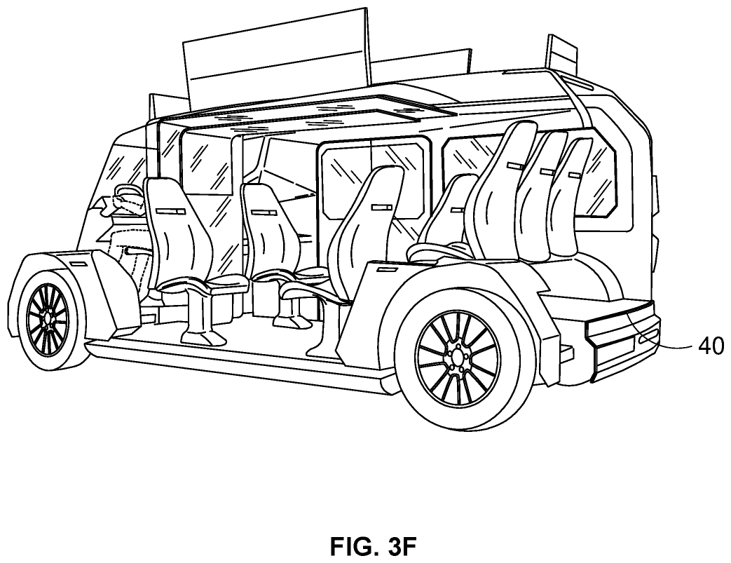

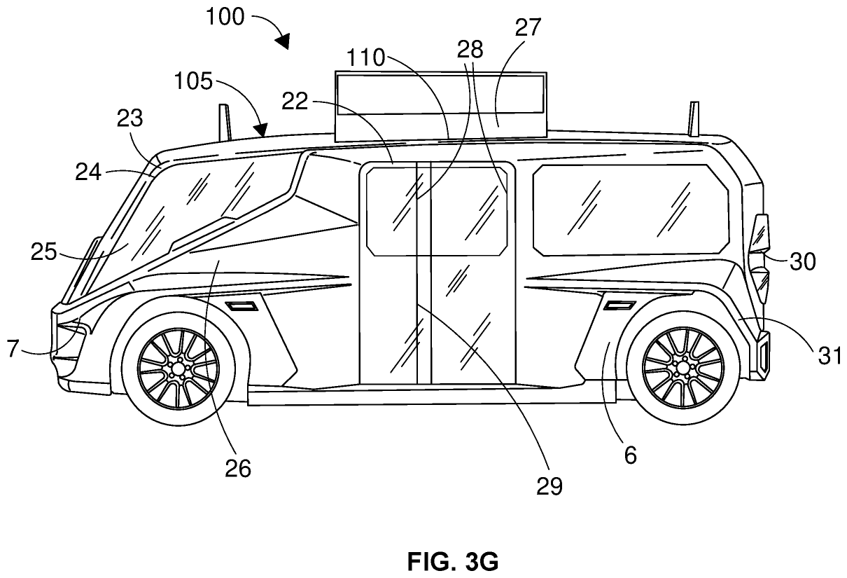

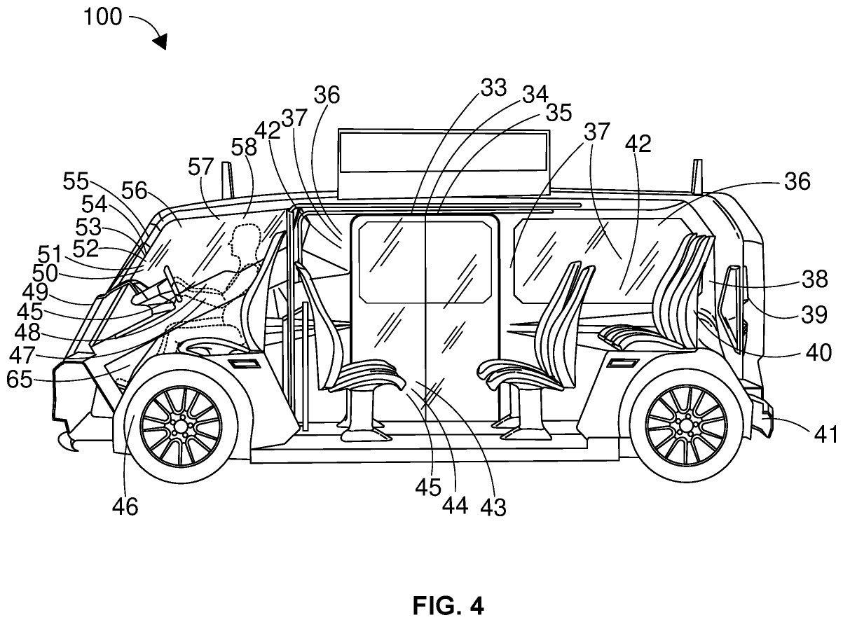

Referring to FIG. 3a, the vehicle 100 may be thought of as having a plurality of pods. A driver pod 105 may be provided and a passenger pod 110 may be provided. The driver pod 105 may be separated from the passenger pod 110. The pods may be entirely separate but connected to the same space frame or the pods may simply be separated by a sound and air barrier. Of course, other configurations of the pods may be possible and are contemplated.

In some embodiments, the driver seat 20 may be elevated such that the driver may have a superior view of the vehicle 100 and the surroundings The driver pod 105 may have a separate air supply than the passenger pod. Separate air intakes may be provided for each pod and each pod may have a separate air cleaning system. Further, the driver pod 105 and passenger pod 110 may be separated in such a way that sound may be limited in how it may be communicated between the pods. In such an embodiment, an in-vehicle 100 communication system may be provided such that the driver may select to communicate to the passenger pod 110 and the passenger pod 110 may select to communicate to the driver Logically, either the driver 105 or passenger pod 110 may select to not communicate with the other pod. Similarly, video sensing devices may be provided in the driver pod 105 and the passenger pod 110. The driver may be able to easily see on a display in the driver pod 105 that the passenger are safely buckled into the passenger pod 110 and the passengers may be able to ensure the driver is awake and paying attention.

The passenger pod 110 may also include a display that indicates at least one of a current price, a pickup location, a path to destination, progress to destination, an indication of crypto-currency mined during the trip; a current fare, relevant advertisement and a destination. The passenger pod 110 may also include a passenger protection system. The seats and air bags may be designed to protect passengers in case of an accident. The seats also may be designed to be easily moveable and rearrange-able to maximize passenger comfort. For example, a group as friends may desire to face each other and chat during a ride while stranger may desire privacy and the seats may be arranged to provide additional privacy.

The passenger pods 110 may also include a vending machine where the vending machine costs are added to the taxi bill. For example, if the user desires snacks during a trip, snacks may be purchased and the fare may be increased by the cost of the snacks. Logically, the good or services from the vending machine may be paid for using crypto currency associated with the transportation system. Payments may be made using wireless payment system such as using a smart phone to transfer value for the fare and any other purchases made in the vehicle 100.

The vehicle 100 may include a space frame and thermoplastic panels attached to the space frame. The thermoplastic panels are colored such that the panels do not need to be painted. The vehicle 100 may also include a power system to provide power to the motor and various computing devices and the power system may be designed in an integrated way such a backbone a wiring is part of the space frame and additional modules are connected to the power system. The vehicle 100 may also include a platform capable of assisting loads into the vehicle 100. The platform may be useful to load wheelchairs or boxes other loads which need assistance to enter the vehicle 100.

### Propulsion System

The vehicle 100 may also have an electric propulsion system which may include one or more electric motors and an energy storage system in communication with the electric motors. In some embodiments, a combustion based engine may also be included.

The power storage device may be rechargeable and may receive power in a variety of ways. The power storage device may also include one or more capacitors to provide additional power as needed. In some embodiments, kinetic energy is collected from regenerative brakes or from the motor while coasting or going downhill to provide energy to the energy storage device. In addition, the vehicle 100 may have solar panels on the roof and additional surfaces to provide energy to the energy storage device. The vehicle 100 may also use wind energy from air ports to provide additional energy. In addition, energy may be provided from direct input from a power source such as a charging station.

In some embodiments, the power storage device may be designed to be easily replaceable such as in a drive through type fashion. The power storage device may be held in place using releasable fasteners and the releasable fasteners may be accessible from outside the car. The releasable fastener may also include a lock such that only authorized sources may access the power storage source. The vehicle 100 may include a secondary power storage device capable of maintaining power while the power storage device is temporarily removed.

### Display

The vehicle 100 may also include a computer controlled outward facing display 21. The display 21 may indicate information to a potential passenger such that the passenger may recognize that vehicle 100 is the vehicle 100 requested. In addition, the display 21 may indicate whether the vehicle 100 is available to be request and may include an app name or web address which may be used to request the vehicle 100.

The display 21 may also be used for advertisements. Advertisements may be for sale to outside users. The advertising system may also use outside information to provide relevant advertisements to people in a particular place or on a particular route. For example, if the vehicle 100 is near a school, advertisements related to school supplies may be displayed. The advertisement may be changed in real time based on the riders, location, demographics, Provider. Advertisers may buy coins in packages for airtime on the outward facing display. The advertisers may be rewarded in coins for advertising during non-favorable times/places.

In some embodiments, the billboard display 21 may be retractable to fit into garages and other locations with height restrictions. The billboard display 21 may retract to lie flat or may be withdrawn into the passenger pod.

### Side View

Referring to FIGS. 3a-3g, additional elements of the vehicle 100 may be illustrated in more detail. A light of the passenger door 22 may be provided to assist users entering and leaving the vehicle 100. A blind spot monitoring system 23 may be useful to ensure the vehicle 100 driver can see any blind spot from the driver seat. Dash side cameras 24 be provided to communicate additional images to the driver. Rear view mirrors 25 may be provided to communicate rear views to the driver. A driver door 26 may allow a driver access to the driver pod. The digital billboards 21 may allow a passenger to identify the correct vehicle 100 and may be used to communicate advertisements. Side windows 27 may be provided to allow views outside the side of the vehicle 100. Passenger doors 28 may provide access for passengers to the passenger pod. A stoplight 29 may provide notice to uses that the vehicle 100 intends to stop. Blinkers 30 may provide notice that a driver intends to turn of change lanes, electrically removable bike rack 31 with all necessary lights integrated.

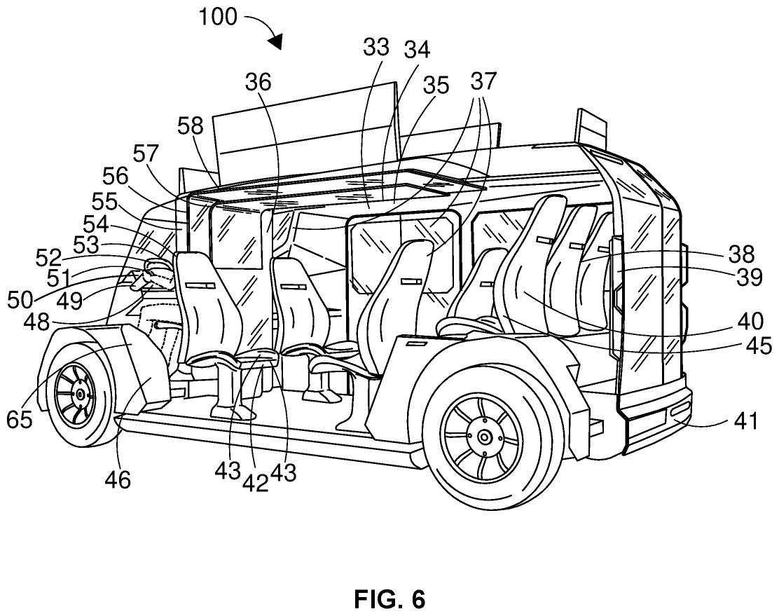

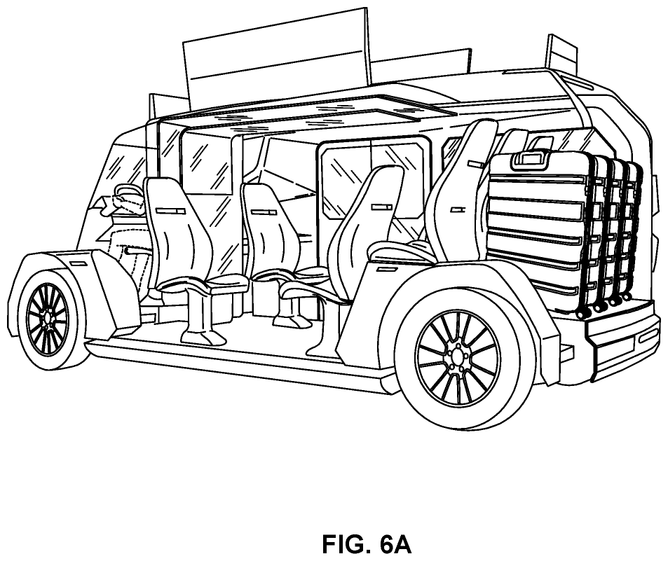

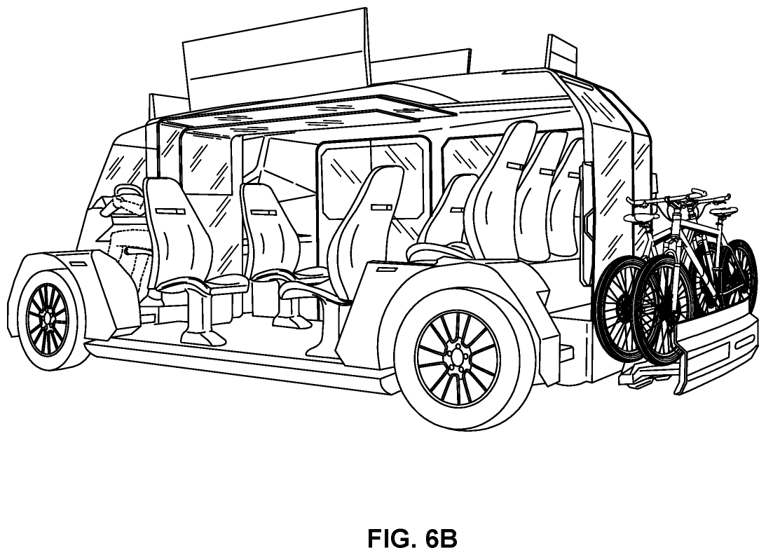

Referring to FIGS. 3b, 3c, 3d and 3e, interior lighting 33 may ease entry and exit from the vehicle 100 and may be used by the users during a trip. An air purification system 34 may be used to clean the air in the pods of the vehicle 100 and removed any unwanted particles, viruses or the like. An automatic disinfection system 35 may periodically disinfect the surfaces of the vehicle 100. Inside cameras 36 may allow a driver to other authority to monitor the safety of passengers,37 anti-hole airless tires. Inside monitor 38 give all the info to the passengers and also it will communicate with them with an artificial intelligence, Digital control screens 38 may be used by passengers to control the environment inside the vehicle 100. Item 39 are service compartments, which also may be used like an extra space for luggage, and a slot 19 for battery swap is provided. Referring to FIG. 6, the luggage space 40 is noted.

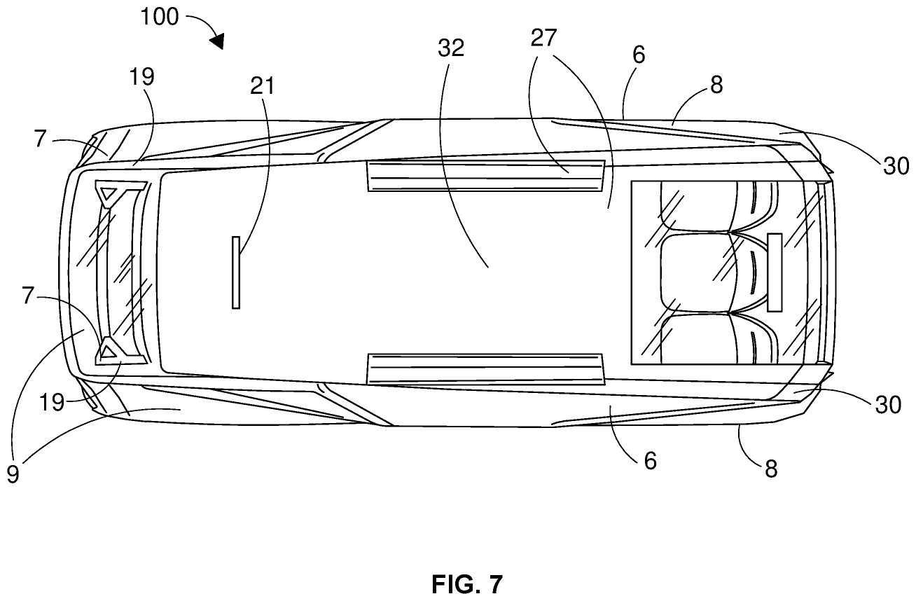

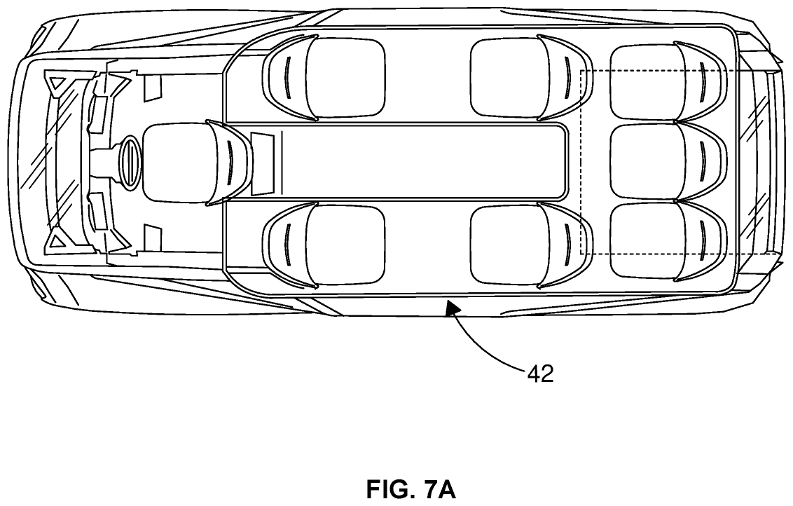

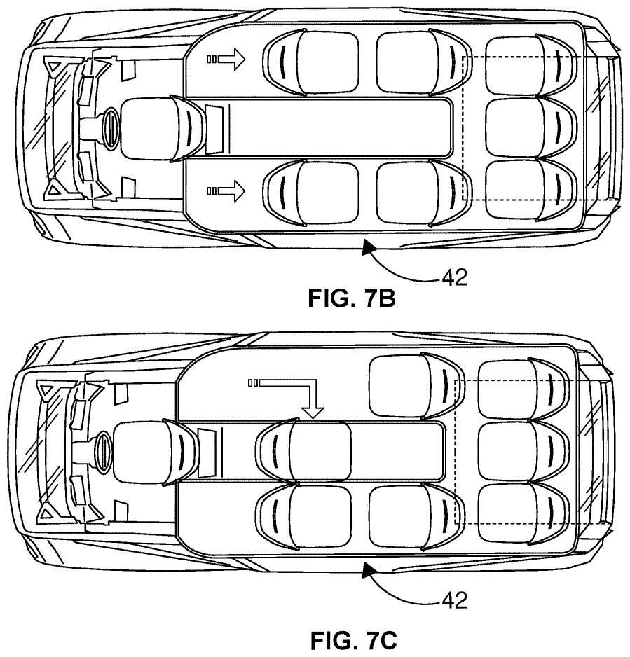

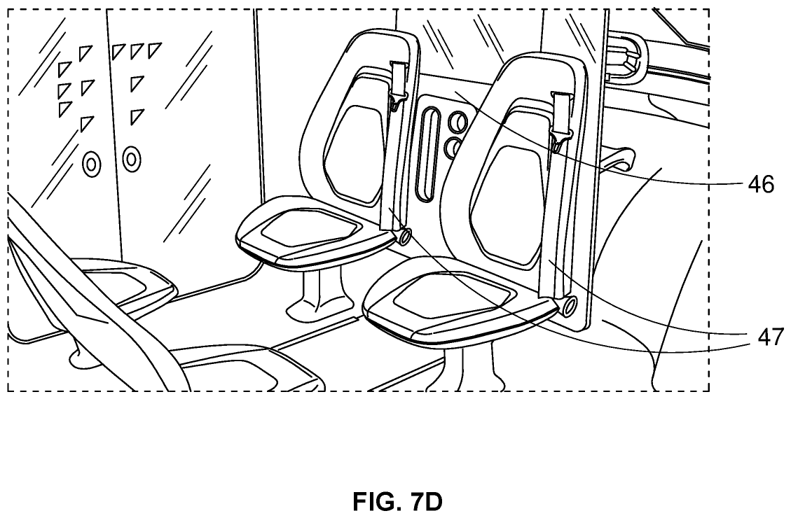

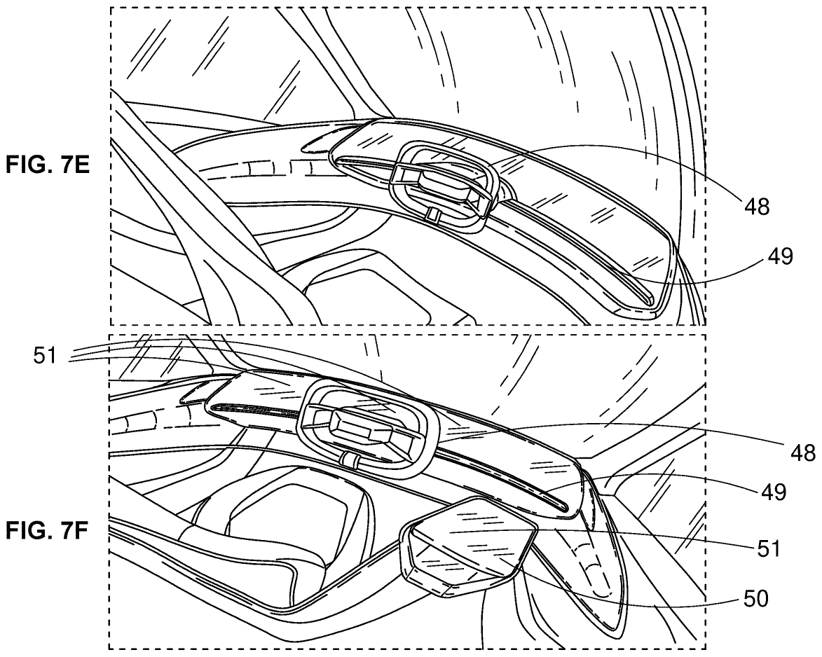

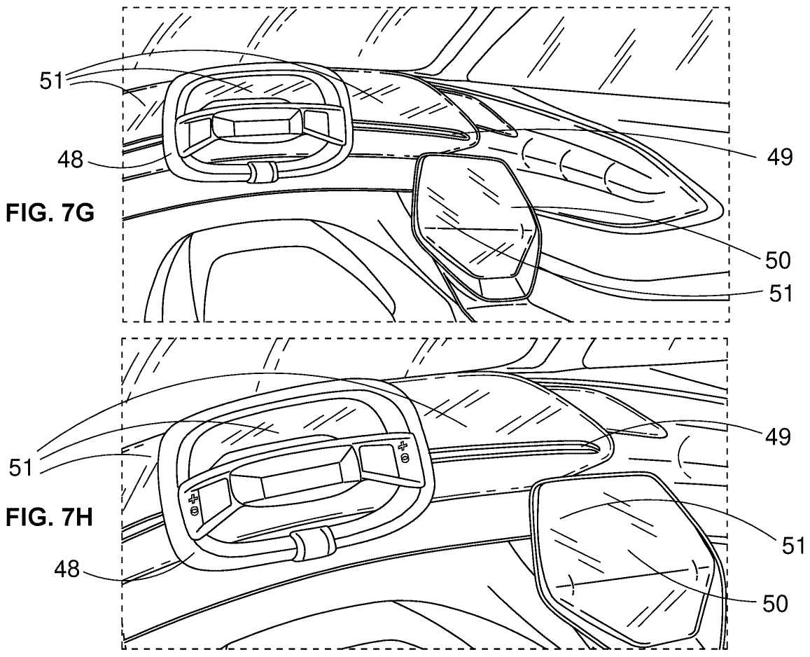

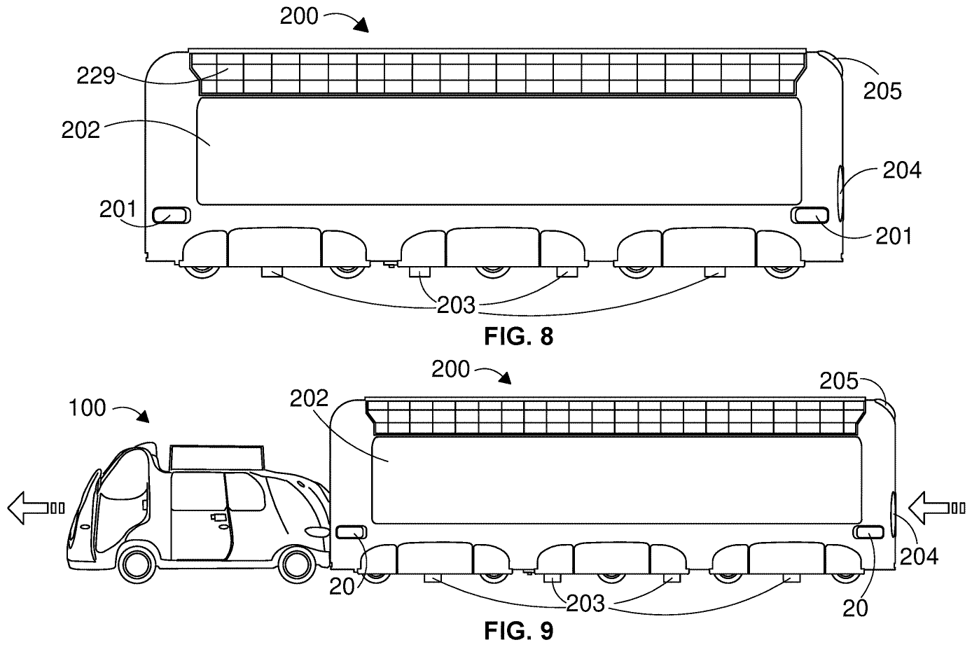

Referring briefly to FIG. 7, the solar panel 32 may provide power to the power storage unit. There may be a passenger door opening 41. Referring again to FIGS. 7a-7d, modular seats 42 may move in a variety configurations and may be accessed through sliding doors. Passenger seats 42 may be provided for passengers and the seats may be easily reconfigured according to passenger desires. For example, a user may select a particular seat set up in advance using an app and the seats may move themselves into the desired positions upon arrival to pick up the user. Sample configurations may be provided to users for selection or users may design their own desired configuration. The seats may be mobile and may have separate propulsion and intelligence systems enable smooth, safe and interference free rearrangement of seats A charger for gadgets are in the seats 42 may be provided and may be in communication with the power storage device. include a minibar 39 from which users may obtain drinks for a fee or for free.

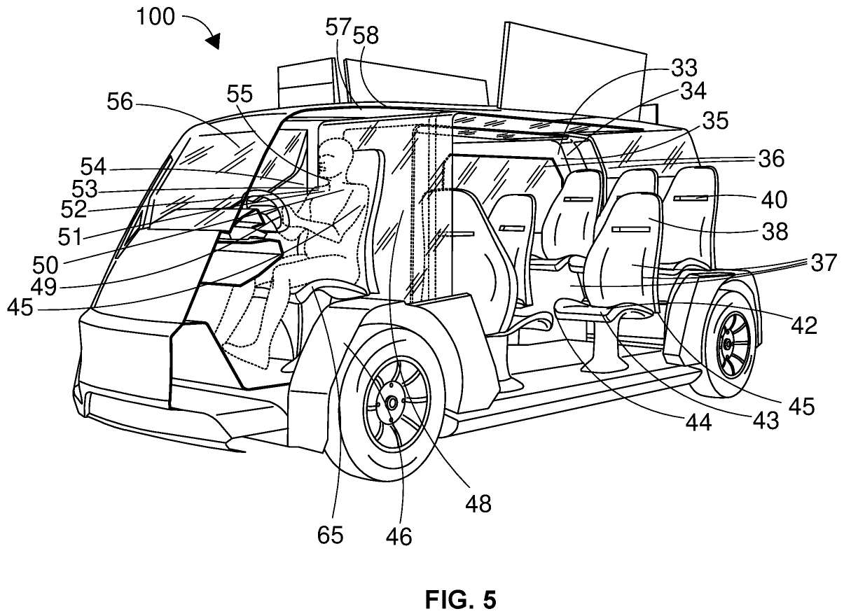

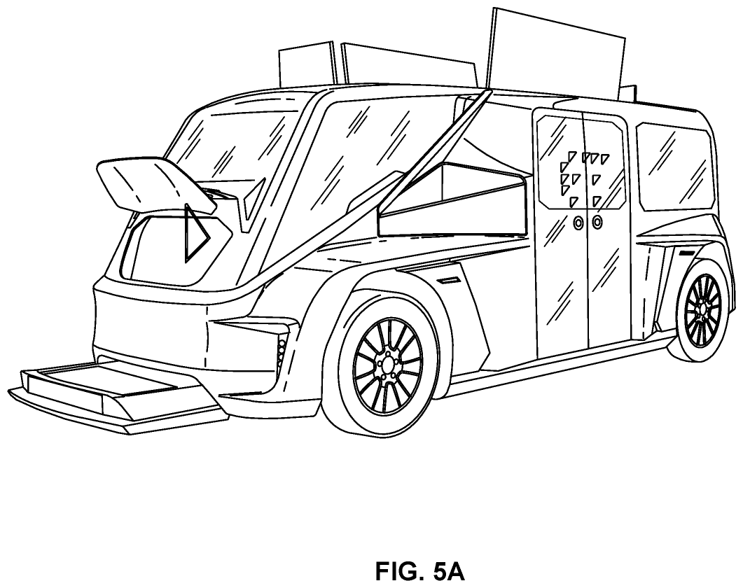

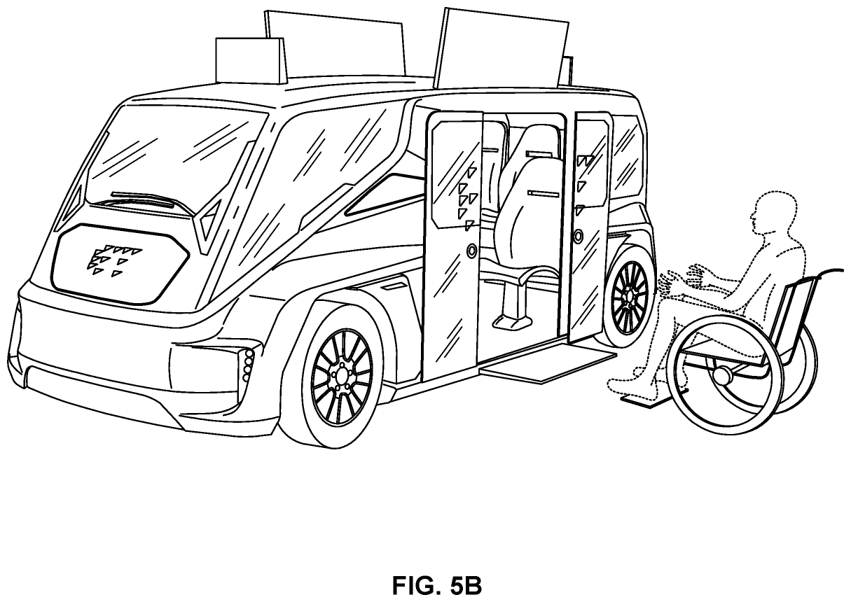

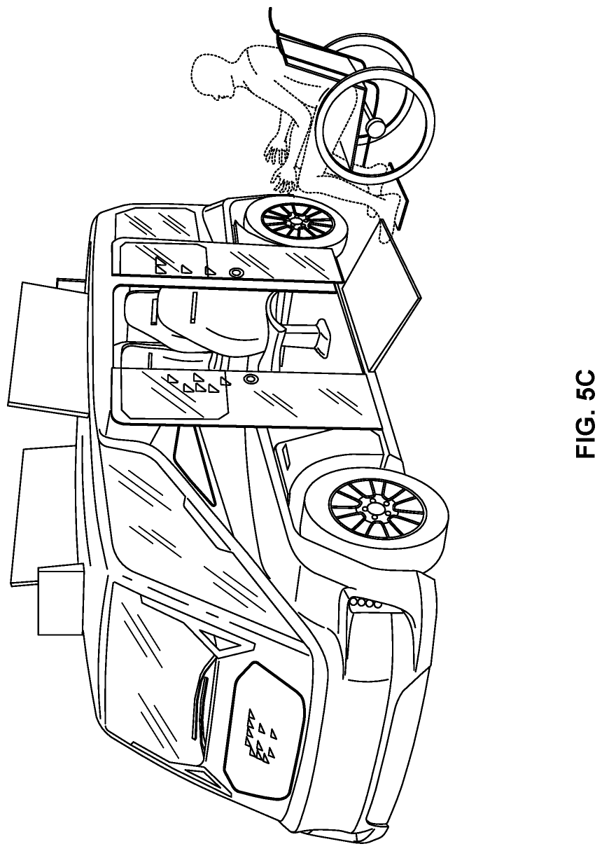

Referring to FIGS. 5b and 5c, operation of a disabled person, the pneumatic suspensions 44 tilt the smart cab to facilitate entry, the sliding ramp 45 for a disabled person may be used to assist disabled users into the vehicle in complete autonomy and may also be used to lift heavy objects like boxes into the vehicle 100.

A ladder may be provided for the driver as the driver pod may be high to provide improved vision for the driver. Airbags may be in the right and left doors to protect the passengers.

Referring to FIGS. 7e-7h, the vehicle 100 also may have a terminal for payment 46 by passengers. In some situations, traditional card readers and bill readers may be used. For example, debit cards may be used to stored crypto coins. The vehicle 100 also may have seat belts 47 for passengers. The steering wheel 48 may allow the driver to control the direction of the vehicle 100. The air conditioner 49 may provide cooling to the vehicle 100. Controls may provide adjustment of glass/mirrors central locking 50.

In some embodiments, a breathalyzer may be included to ensure the driver is safe to drive. A touch screen 50 may be provided to control additional aspects of the vehicle 100 and provide guidance and a digital instrument panel 51 may provide information on the status of the vehicle 100. There may be an airbag in the steering wheel 48 and there may be additional navigation screens 51 to assist the driver. There may be screens 51 in the driver pod to from passenger compartment cameras.

### Charging Station

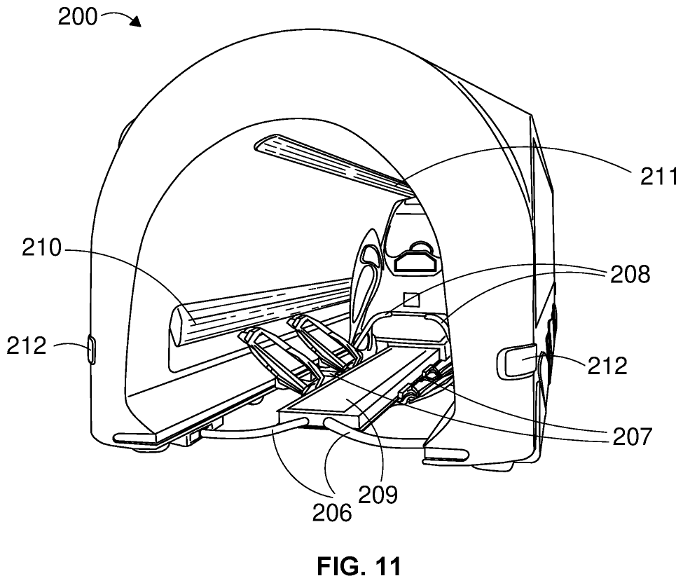

FIGS. 9-14 may illustrate a charge station 200. It should be understood the charging station 200 may have multiple purposes. It may recharge the power storage devices. It may replace the power storage devices. It may wash the vehicle. It may monitor the health of the vehicle. It may provide maintenance services. The following description is just an outline of some of the features and more feature are contemplated.

Winkers 201 on the charging station 200 may assist in informing people that the station is in use. Digital billboards 202 may be used as advertisements and providing information on the system. One or more bracing jacks 203 may be used to provide stability to the charging station 200. A stoplight 204 may be used to ensure vehicles 100 do not run into each other. A light box 205 may be used to assist drivers in entering and exiting the charge station 200.

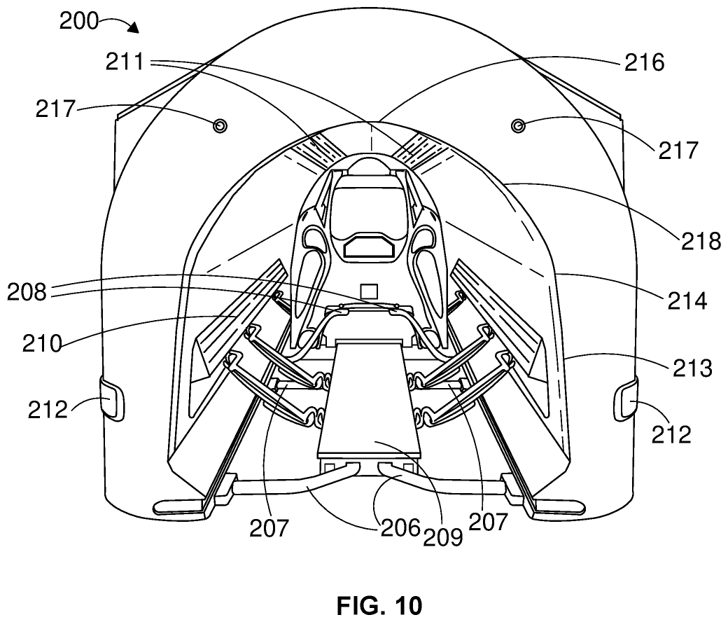

Referring to FIGS. 10, 11 and 12, the charge station 200 may have a frontal battery holder 206 and an additional battery holder 207 which may be used to assisting in swapping out the batteries in the vehicle 100. Fastening levers 208 may move the car forward the tunnel in a controlled fashion. A ready-to-use battery 209 may be fully charged and may be swapped into the vehicle 100. Machine vision may be used to guide the battery swap process. Machine learning may be used to assist in improving the swapping process of time where the system learns from past swaps and improves into the future. A charging battery 210 may be used to hold power and help charge batteries in the charge station 200. LED lights 211 may assist in providing illumination. Winkers 212 may be used to provide notice that the system is in use. A Wi-Fi router 213 and black box information center of the charging station 214 may be used to communicate data about the vehicles 100 and the charging station 200 to a central authority. Sample data may include availability of the batteries, queue to the station and statistics on the vehicle 100 and charging station 200. A fire control system 215 may be in place of a fire. An alarm system 216 may be in place to ensure theft does not occur. Outdoor 360 degree cameras 217 may also help in controlling access to the charging station 200. Indoor cameras 218 may be used to monitor the progress of the vehicle 100 through the charging station 200.

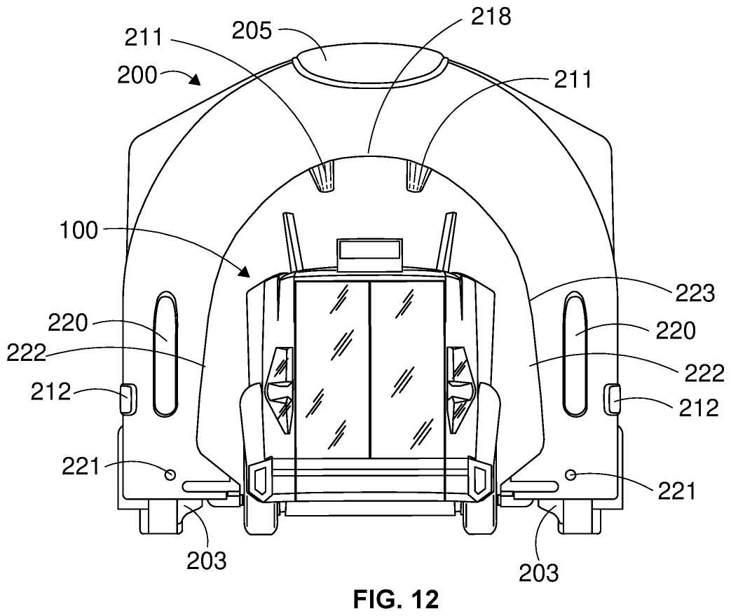

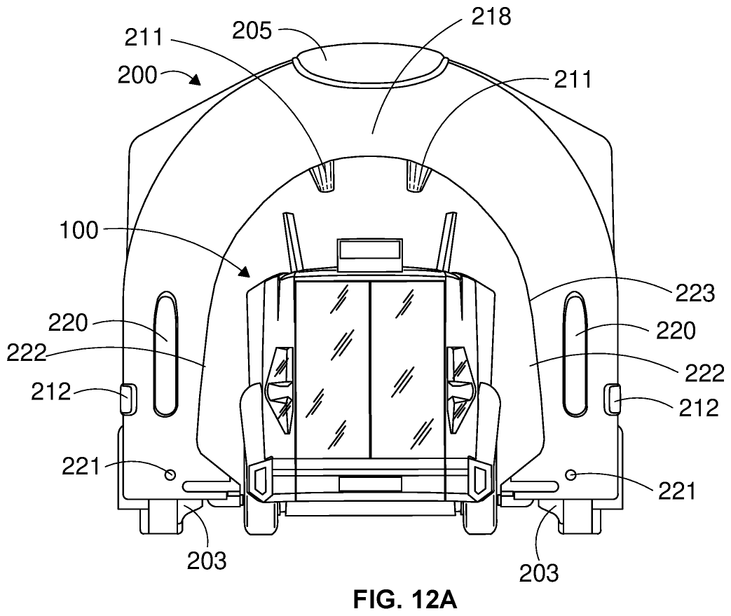

Referring to FIG. 12, in some embodiments the charging station 200 may be portable. Power may also be stored in batteries in the charging station 200. A stoplight 220 may be used to instruction drivers where to stop. Parking sensors 221 may be used to further guide drivers. Terminal for starting the process of battery charge 222 may be provided in cases where vehicle batteries do not need to be swapped out but may be charged. A panic stop 223 may be provided such that drivers do not accidentally leave the charging station 200 before the process is finished, One or more bracing jacks 203 may be used to provide stability to the charging station 200. A stoplight 204 may be used to ensure vehicles 100 do not run into each other. A light box 205 may be used to assist drivers in entering and exiting the charge or washing station 200.

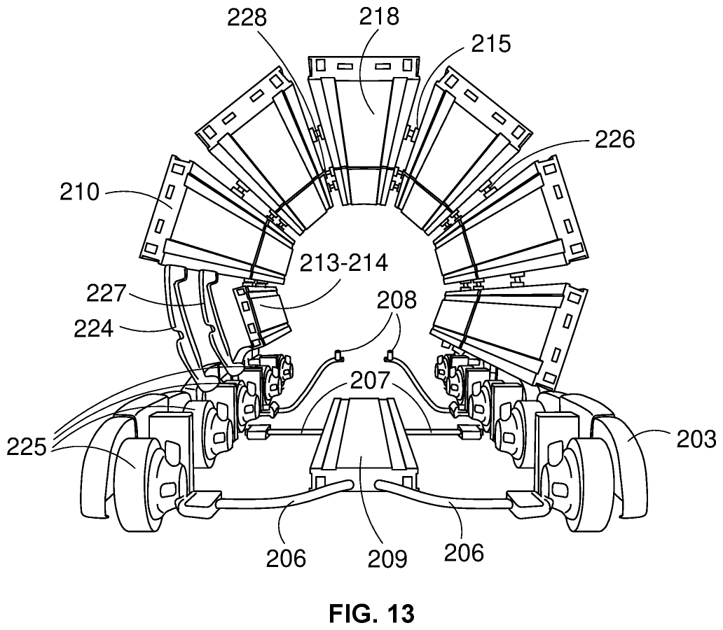

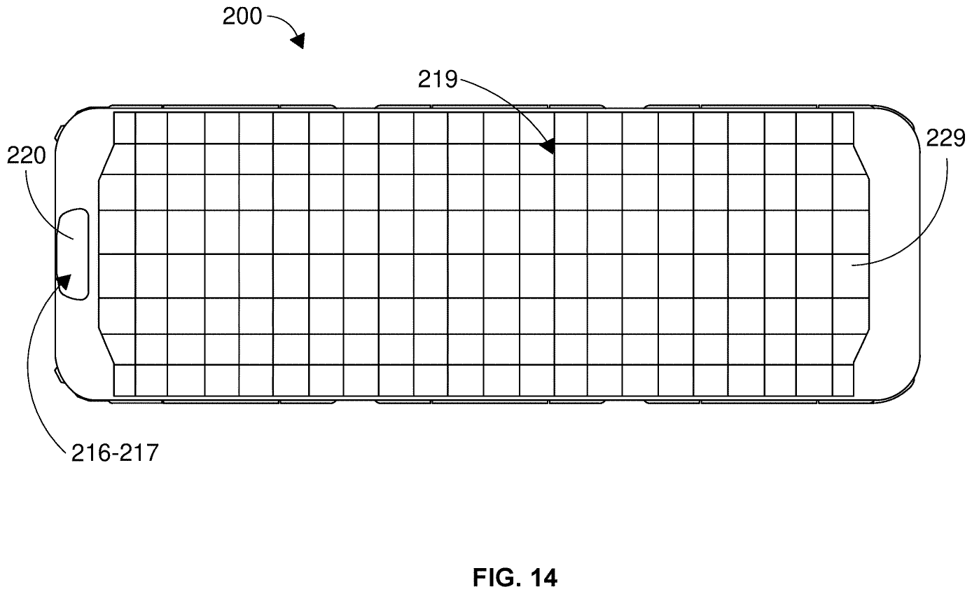

Referring to FIG. 13 and FIG. 14, a battery supply mechanism 224 may illustrated in a cut away view. Wheels with electric engine 225 may be used to propel vehicle 100 through the charging station 200. Used battery charging contacts 226 may be provided in the ceiling. A battery charge control system 220 may be used to ensure the batteries are charged in a safe and efficient manner. A battery storage temperature maintenance system 228 may be used to ensure batteries are stored at an ideal temperature. A solar panel 229 may be used to provide power to the charging station 200. The charge station 200 may have a frontal battery holder 206 and an additional battery holder 207 which may be used to assisting in swapping out the batteries in the vehicle 100. Fastening levers 208 may move the car forward the tunnel in a controlled fashion. A ready to use battery 209 may be fully charged and may be swapped into the vehicle 100. A charging battery 210 may be used to hold power and help charge batteries in the charge station 200. LED lights 211 may assist in providing illumination. Winkers 212 may be used to provide notice that the system is in use. A Wi-Fi router 213 and a black box computing device 214 may be used to communicate data about the vehicles 100 and the charging station 200 to a central authority. Sample data may include availability of the batteries, queue to the station and statistics on the vehicles 100 and charging station 200. A fire control system 215 may be in place of a fire. An alarm system 216 may be in place to ensure theft does not occur. Outdoor 360 degree cameras 217 may also help in controlling access to the charging station 200. Indoor cameras 218 may be used to monitor the progress of the vehicle 100 through the charging station 200.

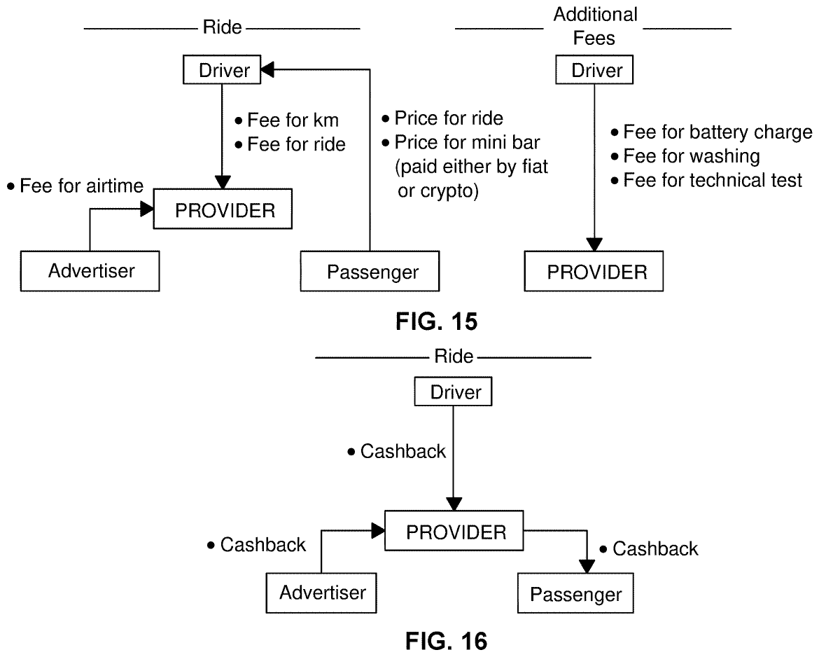

Referring to FIG. 15, in operation, value or money may flow the system in a variety of ways. passengers may pay for a ride with either coins or fiat currency. Drivers may pay a fee to the provider for the distance traveled and a fee for the ride. Advertiser may pay a fee for airtime on the advertising boards on the vehicle 100. The driver also may pay for battery charging/battery exchange, a wash fee and a fee for a technical test of the vehicle 100.

Referring to FIG. 16, mined crypto coins may flow to the driver as a type of cash back. Similarly, the crypto coins may flow to the passenger as a type of cash back. Finally, crypto coins may flow back to the advertiser as a type of cash back for advertising, especially in low demand situations.

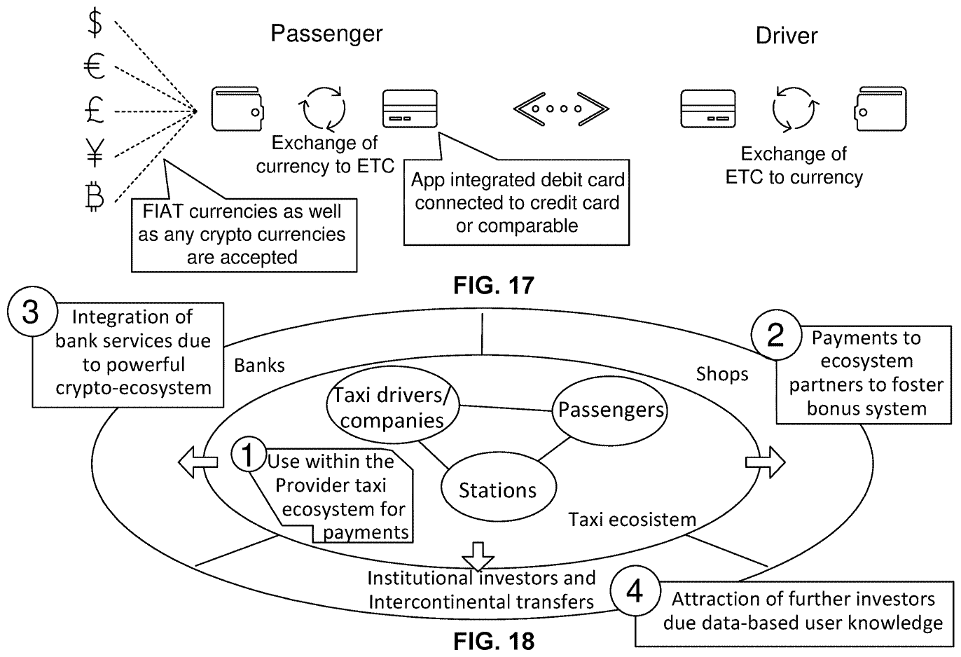

Referring to FIG. 17, in the ecosystem, passengers may use fiat currencies. The currencies may be exchanged into crypto coins. The exchange may happen inside the vehicle 100 or may occur remotely using wireless communication. In some embodiments, the app used by the uses may perform the conversion. The app may also have the ability to use credit cards to pay for travel and provide value. The value may be communicated to the driver in a variety of ways such as through a debit card or through a peer to peer exchange. The driver may receive the value and may exchange the value into a desired store of value such dollar or crypto coins.

Referring to FIG. 18, the taxi cab ecosystem may be the center of a larger crypto coin system. Inside the taxi ecosystem, providers, charging stations and passengers may gain and use crypto coins. The crypto coins may be used to make payments to shops that partner with the crypto coin system. Banks may also join the ecosystem to assist in converting crypto coins to fiat currencies and vice versa. Finally, institutional investors may be interested in being part of the coin ecosystem.

### Driver

In some embodiments, the driver may be a human and in other embodiments, the driver may be an automated or a combination of human and automated systems may be used. If the driver is an automated system, the automated system may use the power source to supply power to the automated system.

### Mining Computer

The vehicle 100 may also include a mining computer 1900 (FIG. 19) specifically designed to mine crypto currency. The mining computer 1900 may operate at high speeds but may designed to use low power. For example, a mining computer 1900 may not need a sophisticated display system as the display from the mining computer 1900 may be minimal which may save power. High speed memory which uses minimal power may also be used and the processor may be cooled using outside air or from the cooling system from the vehicle 100 itself. Machine learning may be used to improve the power management of the vehicle. For example, if an air cooling unit needs power, the mining computer may be allocated less power for a period of time.

FIG. 19 may illustrate a sample crypto computer 1900. The crypto computer 1900 may be adapted to run at high speed but use a minimal amount of power to save the power stored in the power unit of the vehicle 100. The computer 1900 may have an input circuit 1901, a memory 1905, a power source 1910 and the processor 1915. The processor 1915 may also be in communication with a display 1920 and a communication circuit which may communicate the relevant data to an authority.

The mining computer 1900 may be adapted to mine cryptocurrency where the crypto-currency coins may be valued at a fixed rate to a known currency. The coins may be converted into FIAT currencies. In some embodiments, the crypto-currency coins may be awarded based on the distance traveled by the vehicle 100. In other embodiments, the crypto-currency coins may be awarded based on the value of the fare for the vehicle 100. The coins mined by mining computer may be shared with the rider. Thus, the longer the ride or the higher the fare, the more coins may be shared with the rider.

The coins may accumulate in an electronic wallet for future transactions. The coins may be used to purchase other goods/services. The vehicle 100 rider may earn a discount if the rider pays with coins. The driver may also be compensated in coins based on rides completed.

A blockchain may be used to validate the cryptocurrency. Validation of the blockchain may occur in the vehicle 100 using a validation computer. The blockchain may include one or more of the group traveled distance, payments to different participants and type of payment (coin or fiat). An award for validation may be given to the vehicle 100 driver.

### App for Calling for Ride

An app may be used to call for the vehicles 100. The vehicles 100 may have GPS and the location of the vehicle 100 may be tracked by an authority computing system. The authority may also track the status of the vehicle 100 such as a ride is near an end or that the vehicle 100 is ready to stop driving for the day. The central authority may determine the most efficient pick up for rides and may determine the most efficient paths for drivers. The central authority also may measure demand and may determine pricing for ride. The app may display the various determinations from the central authority to a rider such that the rider may the likely fare, the time to pick-up and the time to reach a destination. Machine learning may be used to assist in improving pick up routing and path routing over time.

### App for Managing Funds

Cryptocurrency, sometimes called crypto-currency or crypto, may be any form of currency that exists digitally or virtually and uses cryptography to secure transactions. Cryptocurrencies do not have a central issuing or regulating authority, instead using a decentralized system to record transactions and issue new units.

### Crypto Currency

Cryptocurrency may be a digital payment system that doesn't rely on banks to verify transactions. It's may be peer-to-peer system that can enable anyone anywhere to send and receive payments. Instead of being physical money carried around and exchanged in the real world, cryptocurrency payments may exist purely as digital entries to an online database describing specific transactions. When you transfer cryptocurrency funds, the transactions may be recorded in a public ledger. Cryptocurrency may be stored in digital wallets.

### How Does Cryptocurrency Work?

Cryptocurrencies may run on a distributed public ledger called blockchain, a record of all transactions updated and held by currency holders. Units of cryptocurrency may be created through a process called mining, which involves using computer power to solve complicated mathematical problems that generate coins. Users may also buy the currencies from brokers, then store and spend them using cryptographic wallets.

If a user owns cryptocurrency, the user may not own anything tangible. What the user may own is a key that allows you to move a record or a unit of measure from one person to another without a trusted third party.

### Blockchain

Cryptocurrencies are usually built using blockchain technology. Blockchain describes the way transactions are recorded into “blocks” and time stamped. It's a fairly complex, technical process, but the result is a digital ledger of cryptocurrency transactions that is difficult for hackers to tamper with. In addition, transactions require a two-factor authentication process. For instance, you might be asked to enter a username and password to start a transaction. Then, you might have to enter an authentication code sent via text to your personal cell phone.

Unlike government-backed money, the value of virtual currencies is driven entirely by supply and demand which can create wild swings that produce significant gains for investors or big losses. Cryptocurrency investments are subject to far less regulatory protection than traditional financial products like stocks, bonds, and mutual funds.

What a blockchain may do is to allow the data held in that database to be spread out among several network nodes at various locations which not only creates redundancy but also maintains the fidelity of the data stored therein. If somebody tries to alter a record at one instance of the database, the other nodes would not be altered and thus would prevent a bad actor from doing so. If one user tampers with Bitcoin's record of transactions, all other nodes would cross-reference each other and easily pinpoint the node with the incorrect information. This system may help to establish an exact and transparent order of events as no single node within the network can alter information held within it.

Because of the blockchain design, the information and history (such as of transactions of a cryptocurrency) may be irreversible. Such a record may be a list of transactions (such as with a cryptocurrency), but it also is possible for a blockchain to hold a variety of other information like legal contracts, state identifications, or a company's product inventory.

### Transparency

Because of the decentralized nature of Bitcoin's blockchain, all transactions may be transparently viewed by either having a personal node or using blockchain explorers that allow anyone to see transactions occurring live. Each node may its own copy of the chain that gets updated as fresh blocks are confirmed and added. This means that if a user wanted to, you could track Bitcoin wherever it goes.

The records stored in the Bitcoin blockchain (as well as most others) may be encrypted. As a result, only the owner of a record may decrypt it to reveal their identity (using a public-private key pair). As a result, users of blockchains may remain anonymous while preserving transparency.

### Blockchain Security

Blockchain technology may achieve decentralized security and trust in several ways. New blocks are always stored linearly and chronologically. That is, new blocks may be always added to the “end” of the blockchain. After a block has been added to the end of the blockchain, it may be extremely difficult to go back and alter the contents of the block unless a majority of the network has reached a consensus to do so. Each block contains its own hash, along with the hash of the block before it, as well as the previously mentioned time stamp. Hash codes are created by a mathematical function that turns digital information into a string of numbers and letters. If the block information is edited in any way, then the hash code changes as well.

If a hacker was to alter their own single copy, it would no longer align with everyone else's copy. When everyone else cross-references their copies against each other, they would see this one copy stand out, and that hacker's version of the chain would be cast away as illegitimate. Succeeding with such a hack would require that the hacker simultaneously control and alter 51% or more of the copies of the blockchain so that their new copy becomes the majority copy and, thus, the agreed-upon chain. Such an attack would also require an immense amount of money and resources, as they would need to redo all of the blocks because they would now have different time stamps and hash codes. Doing such a thing would not go unnoticed, as network members would see such drastic alterations to the blockchain. The network members would then hard fork off to a new version of the chain that has not been affected. This would cause the attacked version of the token to plummet in value, making the attack ultimately pointless, as the bad actor has control of a worthless asset. The same would occur if the bad actor were to attack the new fork of Bitcoin. It is built this way so that taking part in the network is far more economically incentivized than attacking it.

In the present system, a Provider wallet, Provider coin trade and its own Provider Coin (Provider) may be created, and these will support:
allowing users to deposit cryptocurrency from external wallets to their Provider-wallet,
paying for Provider services using the cryptocurrencies held in their Provider-wallets and convert the cryptocurrency held in their Provider-wallets to another form of cryptocurrency or fiat and will be combined with a variety of cryptocurrency offerings;
processing payments, providing escrow services, facilitating international cash transactions;
buying and selling cryptocurrencies (through a 3rd party liquidity provider);
enabling Provider customers to deposit Provider coins, fiat money (in collaboration with the 3rd party provider) or cryptocurrency support individual, corporate and institutional clients with own accounts (by providing crypto wallets and IBANs (the latter through a 3rd party service provider)) as well as omnibus account services including on/off-ramping for digital exchanges and Blockchain networks;
enabling fiat payments (including International payment services (USD, EUR, CHF, AED, RUB, NOK, ILS, BRL, CAD, TRY)), transfers and card services (both virtual and physical cards) into the Provider Ecosystem (by relying on a regulated 3rd party service provider to connect the traditional financial services with the Crypto world in Provider);
allowing customers to conduct any transfers (of both crypto assets and/or fiat funds) in real time (while now bank transfers are limited, for example, by the length of the payment day and by the fact that banks and companies in different countries use different systems and therefore, a money transfer can take more than one day);
providing a Crypto exchange market to change Provider coins to any other crypto currency, the same with fiat money (i.e. different currencies);
providing access to other cryptocurrency wallets (Bitcoin, Etherium or other crypto assets, fiat money).

All users may transfer their fiat money & cryptocurrency, after that it will appear on the fiat balance or Provider balance; and Crypto transaction platform with opened API for developers. The system will allow developers and businesses to integrate Bitcoin, Bitcoin cash, Litecoin and Etherium and other Crypto payments into their businesses or applications.

All Provider customers may have cashback (fiat and/or crypto) depending on certain actions when using Provider in the Provider Ecosystem.

### Passengers

If customers pay with Provider they get a special price, otherwise they get a reward in form of Provider as Provider are created during a ride.

When shopping at ecosystem partners it is possible to pay in Provider at a discount (comparable to payback/miles & more).

### Drivers

Drivers are paid in Provider and have the choice to exchange it into a currency or they can shop at ecosystem partners at a discount (comparable to payback/miles & more).

### Advertisers

Advertisers get rewarded with Provider if they advertise during non-favorable time or at non favorable places. Advertisers buy Provider in packages and can then buy airtime.

### Provider Mining

Provider coins may be a dependable cryptocurrency as Providers coins are worth distance in a cab. Provider coins are only mined, when a distance is driven by a Provider CAB, thus each coin that is mined is backed by FIAT currency used to pay for a ride. After a ride Provider holds the mined coins, which are then bought by other partners.

### Provider Coin Usage

Provider coin are used as a bonus system and loyalty program. Passengers may receive a certain percentage of the fees of a ride returned in form of Provider coins. Therefore, the Provider coins is a discount system allowing the Provider to offer rides at attractive rates while at the same time obeying taxi regulations.

The system may include but is not limited to any combination of a LAN, a MAN, a WAN, a mobile, a wired or wireless network, a private network, or a virtual private network. Moreover, to simplify and clarify the description, it is understood that any number of client computers are supported and can be in communication within the vehicle and authority system.

Additionally, certain embodiments are described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations. In some embodiments, the computing device may be a quantum computing device capable of significantly higher speeds than traditional computing systems which may permit significantly more crypto mining and increased security with more challenging encryption algorithms. Part of the quantum computer may be local and part may be remote with high speed communication assisting the system.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a processor configured using software, the processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities.

Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “embodiments,” “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein.

The technological problem of how to efficiently provide crypto mining and transportation services. By using the power generated by a vehicle, crypto can make use of the excess power available in a vehicle. In addition, the modern design of the vehicle 100 may make transportation more safe and more efficient for riders.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A vehicle comprising:
A driver pod;
A passenger pod;
An electric propulsion system;
A power storage device that is rechargeable via at least one of:
kinetic energy;
solar energy;
wind energy;
or direct input energy;
replaceable within a known time period
A solar charging system;
A computer controlled outward facing display;
A mining computer adapted to mine cryptocurrency using power from the power storage device.

2. The vehicle of claim 1 wherein the mining computer is adapted to mine cryptocurrency wherein the crypto-currency coins are valued at a fixed rate to a known currency.

3. The vehicle of claim 1 wherein crypto-currency coins are awarded based on the distance traveled by the vehicle.

4. The vehicle of claim 1, wherein crypto-currency coins are awarded based on the value of the fare for the vehicle.

5. The vehicle of claim 1, wherein coins mined by mining computer are shared with the rider.

6. The vehicle of claim 5, wherein coins accumulate in an electronic wallet for future transactions.

7. The vehicle of claim 1, wherein the driver is automated.

8. The vehicle of claim 1, wherein the outward facing display communicates advertisements from advertisers.

9. The vehicle of claim 1, wherein a blockchain is used to validate the cryptocurrency.

10. The vehicle of claim 1, wherein the passenger pod comprises a display that indicates at least one of:
Current price;
Pickup location;
Path to destination;
Progress to destination;
Crypto mined during the trip; and
Destination.

11. The vehicle of claim 1, wherein the propulsion system comprises at least one motor that uses power from the power storage device.

12. The vehicle of claim 1, wherein the power storage device is held in place using releasable fasteners.

13. The vehicle of claim 1, wherein the vehicle further comprises a platform capable of assisting loads into the vehicle.

14. The vehicle of claim 1, wherein the passenger pods comprise a wireless payment system

15. The vehicle of claim 1, wherein the vehicle further comprises:
A space frame
thermoplastic panels attached to the space frame.
